(19) United States
(12) Patent Application Publication
(10) Pub. No.: US 2024/0134230 A1
(43) Pub. Date: Apr. 25, 2024

(54) DISPLAY DEVICE

(71) Applicant: TCL CHINA STAR OPTOELECTRONICS TECHNOLOGY CO., LTD., Shenzhen, Guangdong (CN)

(72) Inventor: Bo Hai, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/755,148

(22) PCT Filed: Apr. 11, 2022
(86) PCT No.: PCT/CN2022/086323

§ 371 Date: Apr. 20, 2022

(30) Foreign Application Priority Data
Mar. 7, 2022 (CN) 202210314920.5

(51) Int. Cl. G02F 1/13363; G02F 1/1335

(52) U.S. Cl. CPC G02F 1/133633; G02F 1/133531; G02F 2201/50; G02F 2202/28

(57) ABSTRACT

The present application discloses a display device. Based on that a birefringence of a liquid crystal molecule is symmetrically compensated by using an optical compensation layer, the display device of the present provides a liquid crystal compensation layer on a first polarizer, and the liquid crystal compensation layer adjusts a compensation value through a refractive index difference and a thickness of the liquid crystal molecule. Therefore, the compensation value may match a high phase difference of the display device due to a large adjustment range and a little limitation, thereby improving a dark side-view leakage of the display device, improving a contrast of the display device, and improving an image quality.

### TECHNICAL FIELD

The present application relates to a field of display technology, in particular to a display device.

### BACKGROUND

Conventional vertical alignment liquid crystal display devices have a poor side-view contrast, which affects an image quality of the liquid crystal display device. In particular, with development of high dynamic range image television, there is a higher demand for a contrast of liquid crystal display devices, and a development trend of the panel industry in the future is to increase the contrast of the liquid crystal display devices.

The poor side-view contrast of the conventional vertical alignment liquid crystal display device is mainly caused by dark side-view leakage. As a viewing angle of thin film transistor liquid crystal display devices increases, a contrast and a clarity of a picture decreases, which is due to a fact that the birefringence of liquid crystal molecules in a liquid crystal layer varies with the viewing angle changes. By using a wide viewing angle compensation film for compensation, a light leakage of a dark picture may be effectively reduced, and the contrast of the picture may be greatly improved within a certain viewing angle range. A compensation principle of the compensation film is to correct phase differences generated by the liquid crystal at different viewing angles so that the birefringence of the liquid crystal molecules is symmetrically compensated. However, conventional compensation films employ optical compensation. The optical compensation adjusts a compensation value by stretching a film layer. Since stretching level of the film layer is limited, the compensation value is also limited, and the compensation value may not match the phase differences of the vertical alignment liquid crystal display device. Therefore, an improvement of the dark side-view leakage of the vertical alignment liquid crystal display device is limited.

### Technical Problems

The present application provides a display device to solve a problem that an improvement of a dark side-view leakage of a vertical alignment liquid crystal display device is limited.

### SUMMARY

The present application provides a display device, comprising:
a first polarizer;
a second polarizer, the first polarizer and the second polarizer disposed opposite to each other;
a liquid crystal display panel disposed between the first polarizer and the second polarizer;
wherein the first polarizer includes a first optical compensation layer and a liquid crystal compensation layer; and
the second polarizer includes a second optical compensation layer.

Optionally, in some embodiments of the present application, the first polarizer further includes a first polarizing layer, and the first optical compensation layer and the liquid crystal compensation layer are located between the first polarizing layer and the liquid crystal display panel.

Optionally, in some embodiments of the present application, the second polarizer further includes a second polarizing layer, and the second optical compensation layer is located between the second polarizing layer and the liquid crystal display panel.

Optionally, in some embodiments of the present application, the liquid crystal compensation layer includes a liquid crystal polymer.

Optionally, in some embodiments of the present application, the liquid crystal compensation layer is located between the first polarizing layer and the first optical compensation layer.

Optionally, in some embodiments of the present application, the display device further includes a first support layer located between the first polarizing layer and the liquid crystal compensation layer.

Optionally, in some embodiments of the present application, the first optical compensation layer is located between the first polarizing layer and the liquid crystal compensation layer.

Optionally, in some embodiments of the present application, the display device further includes a first support layer located between the liquid crystal compensation layer and the liquid crystal display panel.

Optionally, in some embodiments of the present application, the display device further includes:
a first pressure-sensitive adhesive layer attached to a side of the liquid crystal display panel close to the first polarizer; and
a second pressure-sensitive adhesive layer attached to a side of the liquid crystal display panel close to the second polarizer.

Optionally, in some embodiments of the present application, the display device further includes:

a first protective layer located on a side of the first polarizing layer away from the liquid crystal display panel.

Optionally, in some embodiments of the present application, the display device further includes:
a second protective layer located on a side of the second polarizing layer away from the liquid crystal display panel.

Optionally, in some embodiments of the present application, a material of the first protective layer is any one of cellulose triacetate, polymethyl methacrylate, and polyethylene terephthalate.

Optionally, in some embodiments of the present application, a material of the second protective layer is any one of cellulose triacetate, polymethyl methacrylate, and polyethylene terephthalate.

Optionally, in some embodiments of the present application, the first optical compensation layer and the second optical compensation layer include a single optical axis compensation film or a double optical axis compensation film.

Accordingly, the present application further provides a display device, comprising:
a first polarizer;
a second polarizer, wherein the first polarizer and the second polarizer are disposed opposite to each other;
a liquid crystal display panel disposed between the first polarizer and the second polarizer;
wherein the first polarizer includes a first optical compensation layer and a liquid crystal compensation layer;
the second polarizer includes a second optical compensation layer; and
the first polarizer is a light-entering side, and the second polarizer is a light-exiting side.

Optionally, in some embodiments of the present application, the first polarizer further includes a first polarizing layer, and the first optical compensation layer and the liquid crystal compensation layer are located between the first polarizing layer and the liquid crystal display panel.

Optionally, in some embodiments of the present application, the liquid crystal compensation layer is located between the first polarizing layer and the first optical compensation layer.

Optionally, in some embodiments of the present application, the display device further includes a first support layer located between the first polarizing layer and the liquid crystal compensation layer.

Optionally, in some embodiments of the present application, the first optical compensation layer is located between the first polarizing layer and the liquid crystal compensation layer.

Optionally, in some embodiments of the present application, optionally, in some embodiments of the present application, the display device further includes a first support layer located between the liquid crystal compensation layer and the liquid crystal display panel.

### Beneficial Effects

The present application provides a display device. The display device includes a first polarizer, a second polarizer, and a liquid crystal display panel; wherein the first polarizer and the second polarizer disposed opposite to each other, the liquid crystal display panel is disposed between the first polarizer and the second polarizer. The first polarizer includes a first optical compensation layer and a liquid crystal compensation layer, and the second polarizer includes a second optical compensation layer. Based on that a birefringence of a liquid crystal molecule is symmetrically compensated by using an optical compensation layer, the display device of the present provides the liquid crystal compensation layer on the first polarizer, and the liquid crystal compensation layer adjusts a compensation value through a refractive index difference and a thickness of the liquid crystal molecule, rather than increasing the compensation value by stretching. Therefore, the compensation value may match a high phase difference of the display device due to a large adjustment range and a little limitation, thereby improving a dark side-view leakage of the display device, improving a contrast of the display device, and improving an image quality.

### BRIEF DESCRIPTION OF THE DRAWINGS

In order to more clearly illustrate the technical solutions in the embodiments of the present application, the accompanying drawings required for use in the description of the embodiments will be briefly described below. It will be apparent that the accompanying drawings in the following description are merely some embodiments of the present application, and other drawings may be obtained from these drawings without creative effort by those skilled in the art.

FIG. 1 is a first schematic structural diagram of a display device according to the present application.

FIG. 2 is an effect diagram of a dark view leakage of a conventional display device.

FIG. 3 is an effect diagram of a dark view leakage of a display device according to the present application.

FIG. 4 is a second schematic structural diagram of a display device according to the present application.

FIG. 5 is a third schematic structural diagram of a display device according to the present application.

FIG. 6 is a fourth schematic structural diagram of a display device according to the present application.

FIG. 7 is a fifth schematic structural diagram of a display device according to the present application.

FIG. 8 is a sixth schematic structural diagram of a display device provided by the present application.

FIG. 9 is a seventh schematic structural diagram of a display device provided by the present application.

FIG. 10 is an eighth schematic structural diagram of a display device provided by the present application.

### DETAILED DESCRIPTION OF THE EMBODIMENTS

The following describes the technical solutions of the embodiments of the present application in a clear and complete manner with reference to the accompanying drawings in the embodiments of the present application. It will be apparent that the described embodiments are only a part of the embodiments of the present application, but not all of the embodiments. Based on the embodiments of the present application, all other embodiments obtained by those skilled in the art without creative effort fall within the scope of the present application.

It should be understood that in the present application, the orientations and the positions indicated by the terms “up”, “below”, “front”, “rear”, “left”, “right”, “inner”, “outside” are based on the orientations and the positions shown in the drawings. The terms are used to describe the present application and to simply the description, rather than indicating or implying the specific orientations and positions of the devices or elements, or operating or configuring in specific orientations, thus, the terms should not be understood as the limitation to the present application. Further, the terms “first”, and “second” are used merely to describe, rather than indicating or implying a relatively importance, or implicitly indicating the number of the features. Thus, the features defined with “first” and “second” may explicitly or implicitly include one or more of the features. In the description of the present application, “a plurality of” means two or more unless specifically defined otherwise.

A poor side-view contrast of the conventional vertical alignment liquid crystal display device is mainly caused by dark side-view leakage. As a viewing angle of thin film transistor liquid crystal display devices increases, a contrast and a clarity of a picture decreases, which is due to a fact that the birefringence of liquid crystal molecules in a liquid crystal layer varies with the viewing angle changes. On a basis of symmetrically compensating the birefringence of the liquid crystal molecules by a compensation film, the present application compensates the birefringence of the liquid crystal molecules in the liquid crystal layer through a liquid crystal compensation layer, and the liquid crystal compensation layer adjusts a compensation value by a refractive index difference and the thickness of the liquid crystal molecules, so that the compensation value may match a high phase difference of the display device due to a large adjustment range and a little limitation, thereby improving the dark side-view leakage of the display device, improving the contrast of the display device, and improving the image quality.

The present application provides a display device 100, which will be described in detail below. It should be noted that the order of description of the following embodiments is not a limitation on the preferred order of the embodiments of the present application.

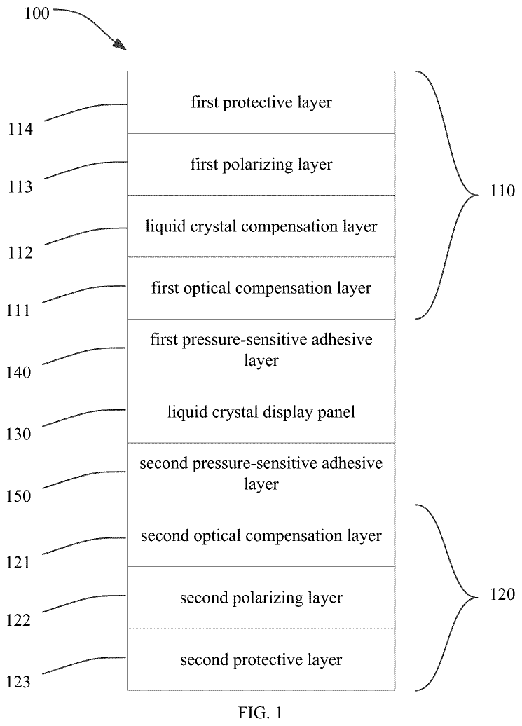

Reference is made to FIG. 1, wherein FIG. 1 is a first schematic structural diagram of a display device 100 according to the display device 100 of the present application. A display device 100 includes a first polarizer 110, a second polarizer 120, and a liquid crystal display panel 130.

The first polarizer 110 and the second polarizer 120 are disposed opposite to each other. The liquid crystal display panel 130 is disposed between the first polarizer 110 and the second polarizer 120. It should be understood that the display device 100 includes a light-entering side and a light-exiting side. In this embodiment, the first polarizer 110 may be referred as a light-entering side, and the second polarizer 120 may be referred as a light-exiting side. Alternatively, the second polarizer 120 may be referred as a light-entering side, and the first polarizer 110 may be referred as a light-exiting side, which is not limited herein.

Referring to FIG. 1, it should be understood that the display device 100 includes an upper polarizer and a lower polarizer. The first polarizer 110 is an upper polarizer or a lower polarizer, and the second polarizer 120 is a lower polarizer or an upper polarizer. Specifically, in the present embodiment, the first polarizer 110 is an upper polarizer, and the second polarizer 120 is a lower polarizer.

Wherein the first polarizer 110 includes a first optical compensation layer 111 and a liquid crystal compensation layer 112, and the second polarizer 120 includes a second optical compensation layer 121.

In some embodiments, the first polarizer 110 further includes a first polarizing layer 113, and the first optical compensation layer 111 and the liquid crystal compensation layer 112 are located between the first polarizing layer 113 and the liquid crystal display panel 130.

In some embodiments, the second polarizer 120 further includes a second polarizing layer 122, and the second optical compensation layer 121 is located between the second polarizing layer 122 and the liquid crystal display panel 130.

An absorption axis of the first polarizing layer 113 is disposed at a first angle, an absorption axis of the second polarizing layer 122 is disposed at a second angle, wherein the first angle may be one of 90° and 0°, and the second angle may be the other one of 90° and 0°. A material of the first polarizing layer 113 and a material of the second polarizing layer 122 is a polyvinyl alcohol film which has a high temperature and humidity resistance characteristic. The high temperature and humidity resistance characteristic of the polyvinyl alcohol film may be realized by adjusting a formulation of the polyvinyl alcohol iodine solution, a stretching ratio and a stretching velocity. Thus, a whole polarizer has high temperature and humidity resistance characteristic. Specifically, steps of determining that the polarizer has a high temperature and humidity resistance characteristic are: for a high temperature resistance characteristic, to take a sample of a polarizer with 40×40 mm, to attach the polarizer to a clean glass with a roller, to place the polarizer in an environment of 80° C.×5 kgf/cm² for 15 min, and to determine whether the high temperature resistance characteristic of the polarizer conforms to a standard at 80° C. and 500 hours; for high humidity resistance characteristic, to take a sample of a polarizer with 40×40 mm, to attach the polarizer to a clean glass with a roller, to place the polarizer in an environment of 80° C.×5 kgf/cm² for 15 min, and to determine whether the humidity resistance characteristic of the polarizer conforms to a standard at 60° C., 90% RH(humidity), and 500 hours; wherein the standard is a polarizer with the monomer penetration change rate ≤5%.

The first optical compensation layer 111 and the second optical compensation layer 121 include a single optical axis compensation film or a double optical axis compensation film. The single optical axis compensation film is an anisotropic birefringent film with only one optical axis. While the double optical axis compensation film has two optical axes and three refractive indices, the double optical axis compensation film has an in-plane phase difference Ro and an out-of-plane phase difference Rth in a thickness direction.

In some embodiments, structures of the first optical compensation layer 111 and the second optical compensation layer 121 may be same, and the first optical compensation layer 111 and the second optical compensation layer 121 are a single optical axis compensation film or a double optical axis compensation film. In other embodiments of the present application, the structures of the first optical compensation layer 111 and the second optical compensation layer 121 are different. The first optical compensation layer 111 is a single optical axis compensation film, and the second optical compensation layer 121 is a double optical axis compensation film. Alternatively, the first optical compensation layer 111 is a double optical axis compensation film, and the second optical compensation layer 121 is a single optical axis compensation film.

Wherein the liquid crystal compensation layer 112 includes a liquid crystal polymer. In contrast to conventional photovoltaic liquid crystal molecules, in addition to the liquid crystal molecule, the liquid crystal polymer has one or more reactive functional groups at an end of the liquid crystal molecule in a molecular structure. The above-described combination may be photopolymerized to form a polymer network, i.e., a liquid crystal polymer. Since most of the polymerization initiators used belong to ultraviolet photosensitive type (having a wavelength of 254 nm to 365 nm), they are also referred to as ultraviolet reactive liquid crystals.

The conventional optical films are formed by a uniaxial or biaxial extension of polymers. The original homotropy of the molecular axes in a random arrangement will be deflected to anisotropy with the extension direction, thereby causing a difference in a traveling speed of an incident light in different directions, that is, a phase retardation phenomenon, which may be used to adjust or compensate a phase of a light.

A general phase retardation amount may be calculated by multiplying a difference Δn in birefringence of a thin film by a thickness d of the thin film, i.e., R=Δnd. However, although an overall anisotropy of the liquid crystal molecules, whether rod-like or dish-like, depends on an arrangement rule, the birefringence of the liquid crystal is basically about 0.1, and the birefringence is 10 times or even 100 times that of a conventional polymer extension film. Therefore, a thickness of the optical film made of the liquid crystal molecules may be very small, and it is very suitable for a roll-to-roll coating process.

Wherein, in some embodiments, the liquid crystal compensation layer 112 is formed by a coating type process, which generally includes a bar coating method, an extrusion coating method, a direct gravure coating method, a reverse gravure coating method, and a die coating method. Specifically, the coating type process is as follows: forming a layer of an alignment film on a substrate, performing a friction alignment treatment on the alignment film, and then applying a liquid crystal polymer to the alignment film for alignment.

In addition, the liquid crystal compensation layer 112 may be formed by forming a liquid crystal polymer on a substrate, and then curing the liquid crystal polymer by ultraviolet light for alignment. The process is relatively simple and rapid.

In the present application, the birefringence of the liquid crystal molecules in the liquid crystal layer is compensated by an optical compensation layer on both sides of the liquid crystal display panel. The compensation principle of the optical compensation layer is generally to correct the phase difference of the liquid crystal at different viewing angles, so that the birefringence of the liquid crystal molecules is compensated symmetrically. Then, according to the present application, the liquid crystal compensation layer 112 is disposed on the first polarizer 110, and the birefringence of the liquid crystal molecules in the liquid crystal layer is compensated by the liquid crystal compensation layer 112. The compensation value of the liquid crystal compensation layer 112 is adjusted by the refractive index difference and the thickness of the liquid crystal molecules, rather than by increasing the compensation value via stretching. Therefore, the compensation value may match the high phase difference of the display device 100 due to a large adjustment range and a little limitation, so that the dark side-view leakage of the display device 100 is further improved, the contrast of the display device 100 is improved, and the image quality is improved.

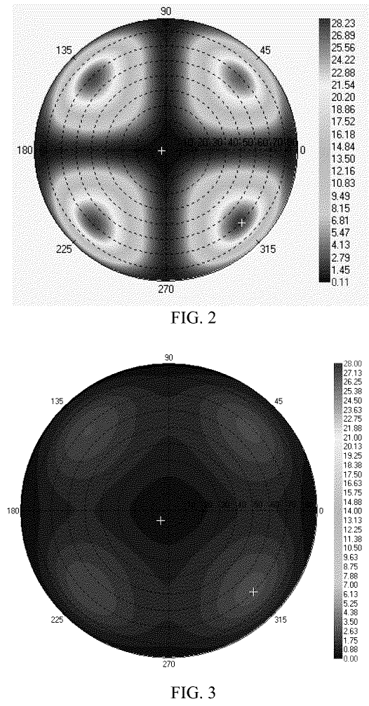

References are made to FIG. 2 and FIG. 3, wherein FIG. 2 is an effect diagram of a dark view leakage of a conventional display device, and FIG. 3 is an effect diagram of a dark view leakage of a display device according to the present application. Referring to following effect comparison table, it is known from the comparison that a maximum value of the dark view leakage of the conventional display device is 28 nits, whilst a maximum value of the dark view leakage of the display device of the present application is 2.3 nits. Therefore, the present application may greatly improve the dark view leakage of the liquid crystal display, improve the contrast of the liquid crystal display, and improve the image quality.

Effect Comparison Table

| | Conventional | Display Device Of The |
|---|---|---|
| | Display Device | Present Application |
| Maximum angle | 28 nits | 2.3 nits |
| of view leakage | | |

Specifically, in some embodiments, the liquid crystal compensation layer 112 is located between the first polarizing layer 113 and the first optical compensation layer 111. That is, the first polarizing layer 113, the liquid crystal compensation layer 112, and the first optical compensation layer 111 are laminated in sequence.

Further, in some embodiments, the display device 100 further includes a first pressure-sensitive adhesive layer 140 attached to a side of the liquid crystal display panel 130 close to the first polarizer 110; a second pressure-sensitive adhesive layer 150 attached to a side of the liquid crystal display panel 130 close to the second polarizer 120. By providing a pressure-sensitive adhesive layer as an adhesive between the liquid crystal display panel 130 and the other layers, a good fixing effect may be achieved in a short period of time by applying a slight pressure to the pressure-sensitive adhesive layer. The pressure-sensitive adhesive layer has advantages that a contact surface may be rapidly wetted like a means of a fluid wetting, and peeling may be prevented like a means of a solid protecting. It should be noted that, as another embodiment of the present invention, the pressure-sensitive adhesive may not be included. Wherein the first pressure-sensitive adhesive layer 140 and the second pressure-sensitive adhesive layer 150 are both polypropylene based adhesives.

Further, in some embodiments, the display device 100 further includes a first protective layer 114 located on a side of the first polarizing layer 113 away from the liquid crystal display panel 130; a second protective layer 123 located on a side of the second polarizing layer 122 away from the liquid crystal display panel 130. Wherein the material of the first protective layer 114 and the second protective layer 123 is any one of cellulose triacetate, polymethyl methacrylate, and polyethylene terephthalate; and the first protective layer 114 and the second protective layer 123 serve as the protective layer of the polyvinyl alcohol film and have a function of isolating moisture and supporting the entire polarizer.

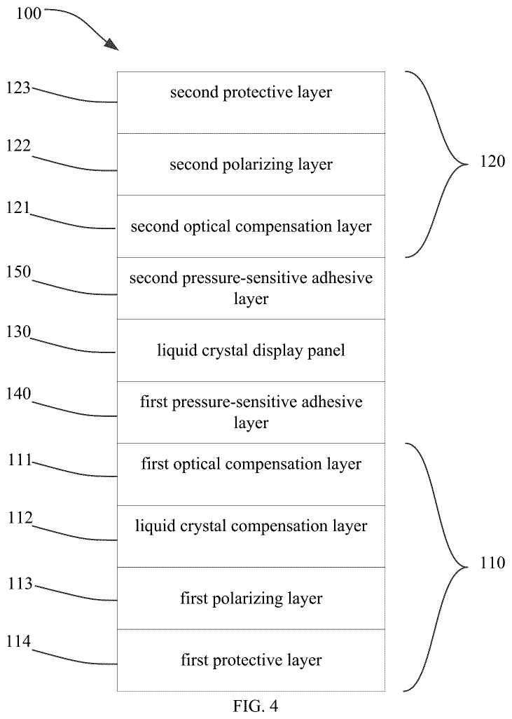

References are made to FIG. 4, wherein FIG. 4 is a second schematic structural diagram of a display device 100 according to the present application. In this embodiment, the display device differs from the display device 100 provided in FIG. 1 in that: the display device includes an upper polarizer and a lower polarizer, wherein the first polarizer 110 is the lower polarizer, and the second polarizer 120 is the upper polarizer.

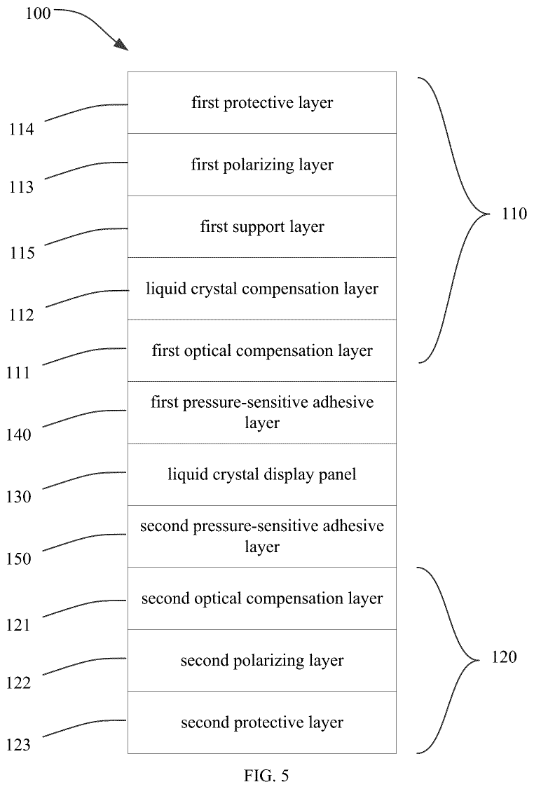

References are made to FIG. 5, wherein FIG. 5 is a third schematic structural diagram of a display device 100 according to the present application. In this embodiment, the display device differs from the display device 100 provided in FIG. 1 in that: the display device further includes a first support layer 115 located between the first polarizing layer 113 and the liquid crystal compensation layer 112. The first support layer 115 is a cellulose triacetate film. The cellulose triacetate film has a high water resistance characteristic, a low thermal shrinkage, a high durability, and the like. The cellulose triacetate film has a function of isolating moisture and supporting. Therefore, the first support layer 115 may protect and support the first polarizing layer 113, and prevent the first polarizing layer 113 from shrinking. Further, since the first support layer 115 is a non-compensating layer, no special process treatment is required, and the manufacturing cost is low.

In this embodiment, the display device 100 includes an upper polarizer and a lower polarizer, wherein the first polarizer 110 is the upper polarizer, and the second polarizer 120 is the lower polarizer.

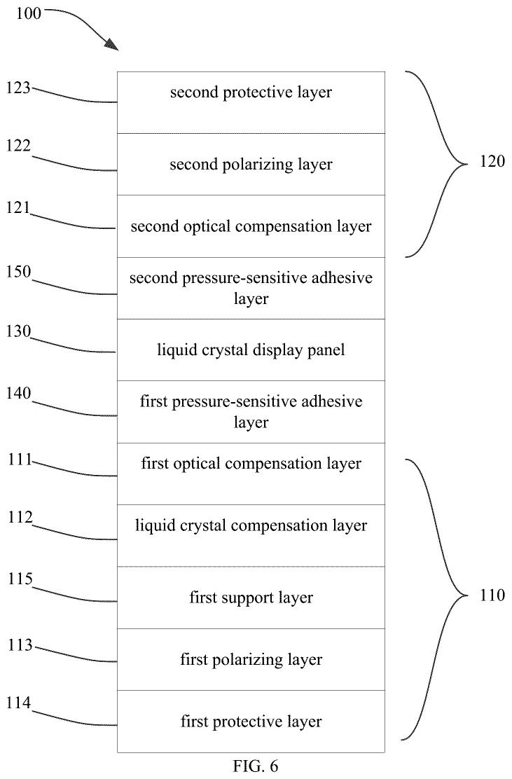

References are made to FIG. 6, wherein FIG. 6 is a fourth schematic structural diagram of a display device 100 according to the present application. In this embodiment, the display device differs from the display device 100 provided in FIG. 5 in that: the display device includes an upper polarizer and a lower polarizer, wherein the first polarizer 110 is the lower polarizer, and the second polarizer 120 is the upper polarizer.

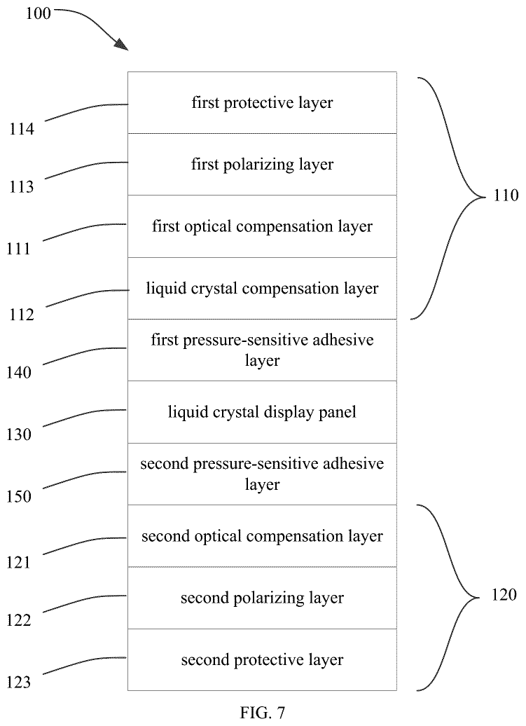

References are made to FIG. 7, wherein FIG. 7 is a fifth schematic structural diagram of a display device 100 according to the present application. In this embodiment, the display device differs from the display device 100 provided in FIG. 1 in that: the first optical compensation layer 111 is located between the first polarizing layer 113 and the liquid crystal compensation layer 112. That is, in this embodiment, the first polarizing layer 113, the first optical compensation layer 111, and the liquid crystal compensation layer 112 are laminated in sequence.

In this embodiment, the display device 100 includes an upper polarizer and a lower polarizer, wherein the first polarizer 110 is the upper polarizer, and the second polarizer 120 is the lower polarizer.

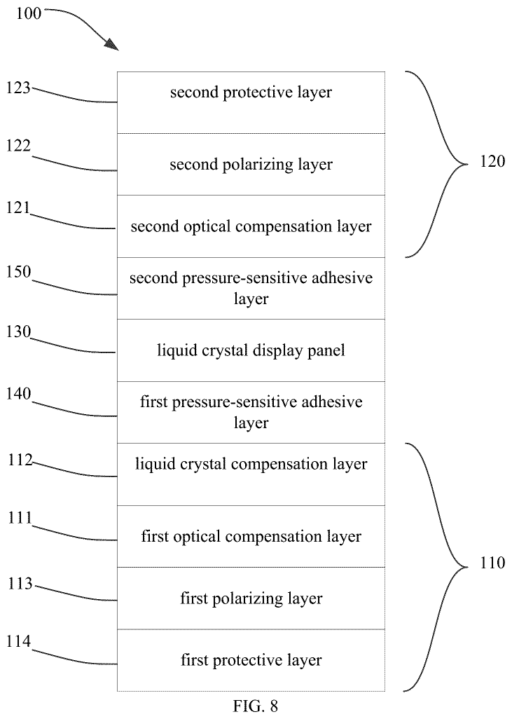

References are made to FIG. 8, wherein FIG. 8 is a sixth schematic structural diagram of a display device 100 according to the present application. In this embodiment, the display device differs from the display device 100 provided in FIG. 7 in that: the display device includes an upper polarizer and a lower polarizer, wherein the first polarizer 110 is the lower polarizer, and the second polarizer 120 is the upper polarizer.

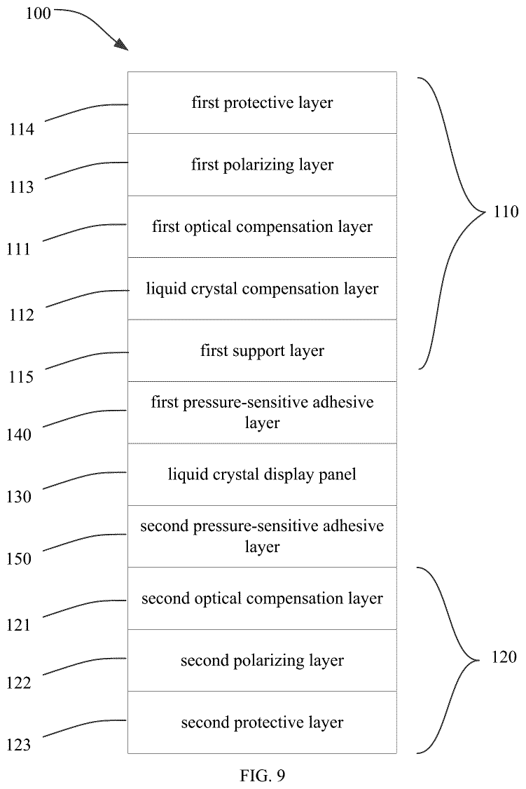

References are made to FIG. 9, wherein FIG. 9 is a seventh schematic structural diagram of a display device 100 according to the present application. In this embodiment, the display device differs from the display device 100 provided in FIG. 1 in that: the display device further includes a first support layer 115 disposed between the liquid crystal compensation layer 112 and the liquid crystal display panel 130. The first support layer 115 is a cellulose triacetate film. The cellulose triacetate film has a function of isolating moisture and supporting, due to characteristics such as high water resistance, a low thermal shrinkage, a high durability, and the like. Therefore, the first support layer 115 may protect and support the liquid crystal compensation layer 112, and prevent the liquid crystal compensation layer 112 from shrinking. Further, since the first support layer 115 is a non-compensating layer, no special process treatment is required, and the manufacturing cost is low.

In this embodiment, the display device 100 includes an upper polarizer and a lower polarizer, wherein the first polarizer 110 is the upper polarizer, and the second polarizer 120 is the lower polarizer.

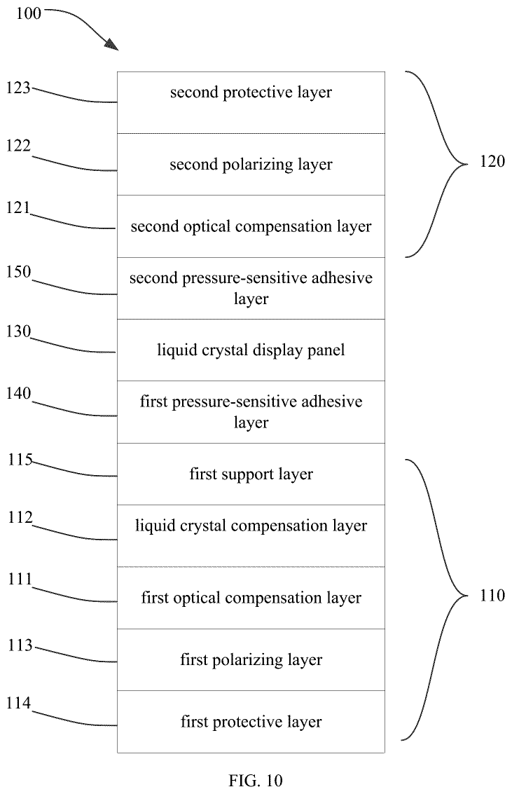

References are made to FIG. 10, wherein FIG. 10 is an eighth schematic structural diagram of a display device 100 according to the present application. In this embodiment, the display device differs from the display device 100 provided in FIG. 9 in that: the display device includes an upper polarizer and a lower polarizer, wherein the first polarizer 110 is the lower polarizer, and the second polarizer 120 is the upper polarizer.

The display device provided in the embodiments of the present application is described in detail above. The principles and embodiments of the present application are described in detail herein. The description of the embodiments is merely intended to help understand the method and core ideas of the present application. At the same time, a person skilled in the art may have changes in the specific embodiments and application scope according to the idea of the present application. As above, the content of the specification should not be construed as a limitation to the present application.

What is claimed is:

1. A display device, comprising:
a first polarizer;
a second polarizer, wherein the first polarizer and the second polarizer are disposed opposite to each other;
a liquid crystal display panel disposed between the first polarizer and the second polarizer;
wherein the first polarizer comprises a first optical compensation layer and a liquid crystal compensation layer; and
the second polarizer comprises a second optical compensation layer.

2. The display device according to claim 1, wherein the first polarizer further comprises a first polarizing layer, and the first optical compensation layer and the liquid crystal compensation layer are located between the first polarizing layer and the liquid crystal display panel.

3. The display device according to claim 1, wherein the second polarizer further comprises a second polarizing layer, and the second optical compensation layer is located between the second polarizing layer and the liquid crystal display panel.

4. The display device according to claim 1, wherein the liquid crystal compensation layer comprises a liquid crystal polymer.

5. The display device according to claim 2, wherein the liquid crystal compensation layer is located between the first polarizing layer and the first optical compensation layer.

6. The display device according to claim 5, wherein the display device further comprises a first support layer located between the first polarizing layer and the liquid crystal compensation layer.

7. The display device according to claim 2, wherein the first optical compensation layer is located between the first polarizing layer and the liquid crystal compensation layer.

8. The display device according to claim 7, wherein the display device further comprises a first support layer located between the liquid crystal compensation layer and the liquid crystal display panel.

9. The display device according to claim 1, wherein the display panel further comprises:
a first pressure-sensitive adhesive layer attached to a side of the liquid crystal display panel close to the first polarizer; and
a second pressure-sensitive adhesive layer attached to a side of the liquid crystal display panel close to the second polarizer.

10. The display device according to claim 2, wherein the display panel further comprises:
a first protective layer located on a side of the first polarizing layer away from the liquid crystal display panel.

11. The display device according to claim 3, wherein the display panel further comprises:
a second protective layer located on a side of the second polarizing layer away from the liquid crystal display panel.

12. The display device according to claim 10, wherein a material of the first protective layer is any one of cellulose triacetate, polymethyl methacrylate, and polyethylene terephthalate.

13. The display device according to claim 11, wherein a material of the second protective layer is any one of cellulose triacetate, polymethyl methacrylate, and polyethylene terephthalate.

14. The display device according to claim 1, wherein the first optical compensation layer and the second optical compensation layer comprise a single optical axis compensation film or a double optical axis compensation film.

15. A display device, comprising:
a first polarizer;
a second polarizer, wherein the first polarizer and the second polarizer are disposed opposite to each other;
a liquid crystal display panel disposed between the first polarizer and the second polarizer;
wherein the first polarizer comprises a first optical compensation layer and a liquid crystal compensation layer;
the second polarizer comprises a second optical compensation layer; and
the first polarizer is a light-entering side, and the second polarizer is a light-exiting side.

16. The display device according to claim 15, wherein the first polarizer further comprises a first polarizing layer, and the first optical compensation layer and the liquid crystal compensation layer are located between the first polarizing layer and the liquid crystal display panel.

17. The display device according to claim 16, wherein the liquid crystal compensation layer is located between the first polarizing layer and the first optical compensation layer.

18. The display device according to claim 17, wherein the display device further comprises a first support layer located between the first polarizing layer and the liquid crystal compensation layer.

19. The display device according to claim 16, wherein the first optical compensation layer is located between the first polarizing layer and the liquid crystal compensation layer.

20. The display device according to claim 19, wherein the display device further comprises a first support layer located between the liquid crystal compensation layer and the liquid crystal display panel.
